(19) United States
(12) Patent Application Publication
(10) Pub. No.: US 2005/0210490 A1
(43) Pub. Date: Sep. 22, 2005

(54) Disk Drive Motor and Disk Drive Device Having the Same

(75) Inventors: Yasuo Shimizu, Kyoto (JP); Koichi Yamamoto, Kyoto (JP); Takanori Nishioka, Kyoto (JP)

Correspondence Address: JUDGE PATENT FIRM;RIVIERE SHUKUGAWA 3RD FL., 3-1 WAKAMATSU-CHO, NISHINOMIYA-SHI, HYOGO, 662-0035, JP

(73) Assignee: NIDEC CORPORATION, Kyoto (JP)

(21) Appl. No.: 10/907,042

(22) Filed: Mar. 17, 2005

(30) Foreign Application Priority Data
Mar. 17, 2004 (JP) JP-2004-076779
Feb. 7, 2005 (JP) JP-2005-030559

(51) Int. Cl. G11B 5/012; G11B 17/00; G11B 17/028; G11B 17/03; G11B 19/20

(52) U.S. Cl. 720/697

(57) ABSTRACT

A motor and a disk drive device having the disk drive motor are disclosed. A bearing bush is arranged on a motor mounting plate constituting a base for mounting on the disk drive device to read/write data from/into a recording disk. A shaft is supported rotatably through a bearing inside the bearing bush. A rotor on which an annular disk is placed is fixed at the upper end of the shaft. A rotor magnet is mounted on the inner peripheral wall surface of the rotor. A stator is arranged in opposed relation with the rotor magnet outside the bearing bush. The bearing bush is made of an aluminum alloy, the motor mounting plate is made of an aluminum alloy or a silicon steel plate, and the circuit board is formed of FPC. As a result, the heat generated in the motor can be efficiently radiated. Thus, the disk drive motor and the disk drive device having the motor are reduced in thickness and weight.

### BACKGROUND OF THE INVENTION

1. Field of the Invention

The present invention relates to a motor for driving the recording disks such as CD-ROM, CD-R, CD-RW, DVD-ROM, DVD-RAM or DVD-RW and a disk drive device having the motor.

2. Description of the Related Art

The recent years has seen an advanced portability of OA equipment or especially, the data terminal devices such as PC and AV devices, which in turn has come to require a reduced weight and a reduced thickness of the disk drive device to drive the recording medium such as CD-ROM or DVD constituting a storage unit.

The disk drive motor of this type has a motor mounting plate of iron to secure three functions, i.e. the function of mounting the motor on an exterior, the function of fastening the component parts of the motor integrally and the function of holding a circuit board for controlling the motor. This mounting plate supports a bearing bush made of brass to hold the bearing. A shaft is rotatably supported through a pair of bearings in the bearing bush. A rotor and a turn table made of resin for carrying the disk are fixed on the shaft, and a stator is fixed on the bearing bush in radially opposed relation with an rotor magnet arranged on the rotor. The stator comprises a stator core having a plurality of teeth radially arranged thereon and stator windings wound on each tooth of the stator core.

In the conventional disk drive device described above, an iron plate is used as a motor mounting plate, a brass bearing bush for supporting the bearing, and a resin turn table for carrying the disk. Since iron and brass have a large specific gravity, however, the disk drive motor including the parts made of these materials has a large weight, thereby such motor has a bad portability.

Also, the use of the resin turn table limits the thickness reduction of the disk device to maintain the inclination rigidity.

### BRIEF SUMMARY OF INVENTION

An object of this invention is to provide a lightweight disk drive motor. In order to achieve this object, the motor mounting plate conventionally made mainly of iron is made of light metal such as aluminum. Also, the bearing bush which has conventionally been made of brass is made of light metal such as aluminum. The use of the lightweight aluminum realizes a motor lighter than the conventional one. In addition, the circuit board which has conventionally been made of resin such as epoxy resin is configured as a flexible printed circuit board (FPC). The circuit board of FPC reduces the weight correspondingly. Further, holes or openings are formed in the motor mounting plate to accommodate the stator winding. The weight of the motor mounting is thus reduced by an amount equal to the weight of the metal corresponding to the holes or the openings. By implementing these means wholly or partly, a disk drive motor and a disk drive device having the motor considerably lighter in weight than the conventional disk drive motor and the disk drive device, respectively, are provided.

Another object of the invention is to provide a thin disk drive motor. In order to achieve this object, the motor mounting plate conventionally made mainly of iron is configured by a silicon steel plate. The use of silicon steel higher in strength than iron can reduce the thickness of the motor mounting plate. Also, the circuit board which has conventionally been made of resin such as epoxy resin is configured as a flexible printed circuit board (FPC). The circuit board of FPC reduces the thickness of the circuit board in comparison with the conventional epoxy board. Further, holes or openings are formed in the motor mounting plate and the lower part of each of the stator windings is accommodated into the holes or penetrates the motor mounting plate through each of the openings. As the result of such structure, the position at which the stator is mounted can be lowered, and the total height of the motor in rotational axis direction is reduced in comparison with a conventional one. By implementing the whole or a part of these improvements, a disk drive motor and a disk drive device having the motor considerably thinner than the conventional disk drive motor and the disk drive device, respectively, are provided.

Still another object of the invention is to provide a disk drive motor having a high cooling capability. In order to achieve this object, the motor mounting plate which is conventionally made of iron is made of silicon steel. Also, the bearing bush conventionally made mainly of brass is made of light metal such as aluminum. The use of metal having a higher heat conductivity than iron such as aluminum and/or brass can effectively radiate the heat generated in the motor. Further, holes or openings to accommodate each of the lower parts of the stator winding is formed in the motor mounting plate. The holes or the openings thus formed improve the air permeability and that is why the motor has a higher cooling capability. By executing the whole or a part of these improvements, there is provided a disk drive motor having a very high cooling capability and a disk drive device having the disk drive motor as compared with the conventional motor.

There and other objects, features and advantages of the present invention will become more apparent upon reading of the following detailed description along with the accompanied drawings.

### BRIEF DESCRIPTION OF DRAWINGS

FIG. 1 is a sectional view showing a disk drive motor according to an embodiment of the invention.

FIG. 2 is a sectional view showing a disk drive motor according to another embodiment of the invention.

FIG. 3 is a bottom view showing a disk drive motor according to still another embodiment of the invention.

FIG. 4 is a bottom view showing a disk drive motor according to yet another embodiment of the invention.

### DETAILED DESCRIPTION OF INVENTION

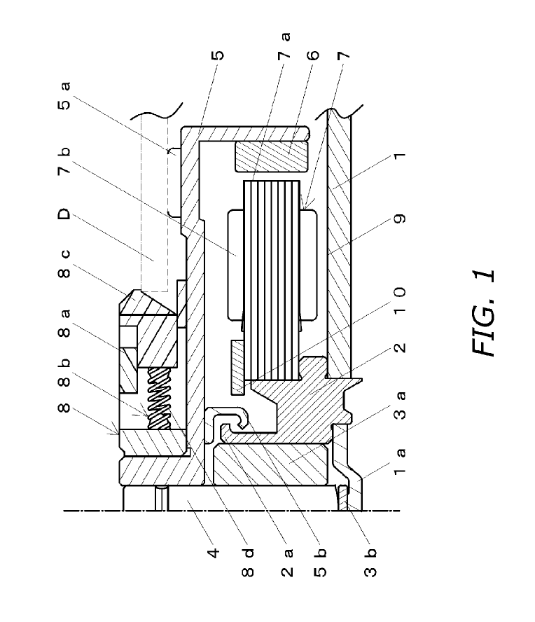

A motor according to embodiments of the invention is explained with reference to FIGS. 1 to 4. This invention, however, is not limited to these embodiments. In the description of the embodiments, the terms “vertical direction” in each drawing is not intended to limit the actual direction in which a device involved is mounted.

FIG. 1 is a sectional view of a disk drive motor according to an embodiment of the invention. In FIG. 1, a bearing bush 2 is arranged on a motor mounting plate 1 providing a base of a disk drive device (not shown) to read/write data from/into a recording disk D. A cylindrical radial bearing 3a of an oil retaining metal is fixedly fitted on the inner peripheral surface of the bearing bush 2. The motor mounting plate 1 and the bearing bush 2 are made of an aluminum alloy. A cover member 1a of a substantially discal aluminum alloy is mounted at the lower end of the bearing bush 2, while a stator 7 is fixed on the outer periphery of the bearing bush 2. The stator 7 includes a stator core 7a of a silicon steel plate having teeth arranged at predetermined pitches along the peripheral direction on the outer diameter thereof, and an aluminum coil 7b wound on the teeth of the stator core 7a. The winding portion of the coil 7b is formed on the teeth.

The radial bearing 3a and the thrust bearing 3b of resin arranged on the upper surface of the cover member 1a rotatably support the shaft 4 to have a rotational axis in vertical direction (axial direction). A substantially cup-shaped rotor 5 is fixed at the upper end of the shaft 4. The upper wall of the rotor 5 doubles as a turn table. An annular buffer member 5a doubling as a stopper of the recording disk D is mounted in the neighborhood of the outer periphery of the upper surface of the rotor 5. Through this buffer member 5a, the recording disk D is placed on the turn table. A substantially annular rotor magnet 6 is arranged in opposed relation with the stator 7 on the inner peripheral surface of the cylindrical wall of the rotor 5 of a magnetic material. An annular magnet 10 is mounted in opposed relation to the upper wall of the rotor 5 inward on the upper surface of the stator core 7a of the stator 7 thereby to attract the rotor 5 downward in axial direction.

A flange 2a is arranged on the outer periphery at the upper end of the bearing bush 2. The flange 2a engages the stopper 5b arranged inward on the lower surface of the upper wall of the rotor 5 adjacent to the flange 2a thereby to prevent the rotor 5 from coming off upward.

A disk aligner 8 is arranged integrally and concentrically with the upper wall of the rotor 5, i.e. the central portion of the turn table. The disk aligner 8 includes a substantially cylindrical resin body case 8a fitted in the central hole of the recording disk D and a plurality of aligning pawl portions 8b having resin aligning pawls 8c energized to protrude radially out of the body case 28 and adapted to move in and out of the disk aligner 8. The aligning pawl portions 8b are arranged equidistantly along the peripheral direction.

A circuit board 9 formed with a rotary drive circuit of the rotor 5 and a coil current control circuit for the stator 7 is arranged with predetermined electronic parts on the upper surface of the motor mounting plate 1 between the stator 7 and the motor mounting plate 1 made of an aluminum alloy. The circuit board 9 is fixed with an adhesive or the like. The circuit board 9 is configured as a flexible printed circuit board, and therefore can be reduced in thickness as compared with the circuit board of epoxy resin accumulated further on the motor mounting plate 1.

Also, the motor mounting plate 1 made of an aluminum alloy may be alternatively made of an aluminum alloy with magnesium, manganese, copper, silicon, zinc or the like and increased in strength by pressure rolling or heat treatment. The resulting use of an aluminum alloy of high strength can reduce the thickness.

The specific gravity of aluminum is about one third that of iron. Once the motor mounting plate 1 and the bearing bush 2 are made of an aluminum alloy, therefore, the disk drive motor can be reduced in weight.

Aluminum has about three times as high a heat conductivity as iron and therefore easily transmits heat. Thus, the heat generated in the motor is propagated to the motor mounting plate 1 from the bearing bush 2 and radiated efficiently out of the motor.

According to the embodiment described above, a silicon steel plate can be used in place of the aluminum alloy for the motor mounting plate 1 shown in FIG. 1. The silicon steel plate, for its high rigidity, makes it possible to form a lightweight, thin motor mounting plate 1 while securing substantially the same rigidity as the conventional mounting plate of iron. Also, the silicon steel plate, which has a higher heat conductivity than iron, transmits heat more easily than an iron plate. The heat generated in the motor, therefore, is propagated to the motor mounting plate 1 of silicon steel from the bearing bush 2 of aluminum alloy and radiated efficiently out of the motor.

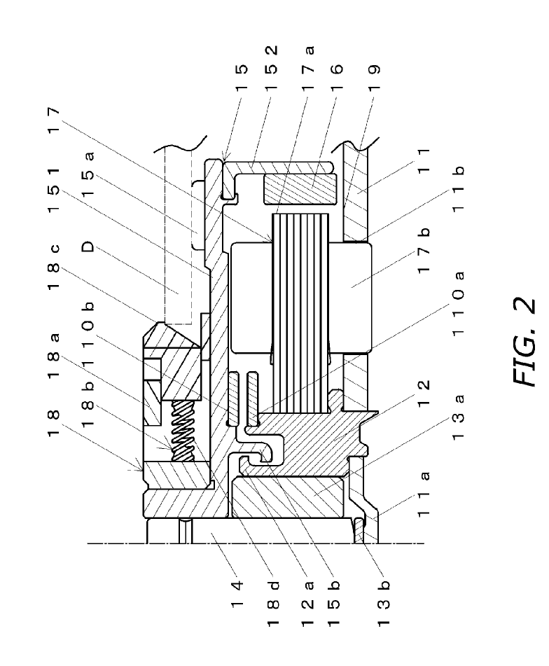

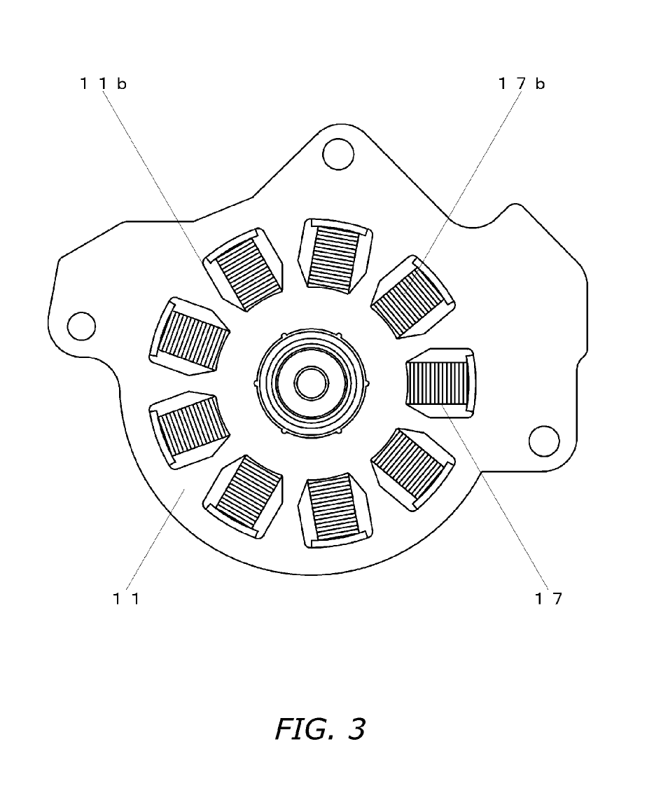

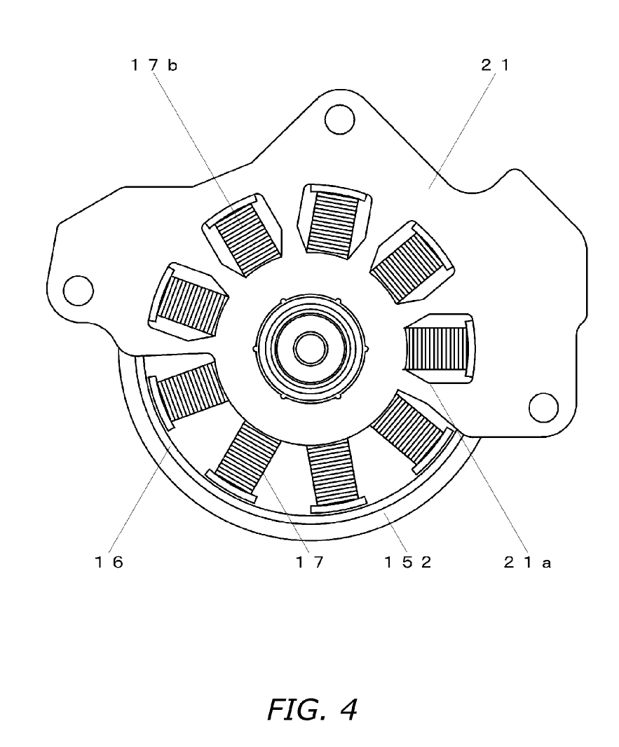

Next, another embodiment is explained with reference to FIGS. 2 to 4. FIG. 2 is a sectional view of the disk drive motor, and FIGS. 3 and 4 bottom views of the disk drive motor taken from the motor mounting plate side. In explaining the basic configuration of the motor according to this embodiment below, FIG. 1 is also referred to.

In FIG. 2, the bearing bush 12 is arranged on the motor mounting plate 111 constituting a base for mounting a disk drive device (not shown) to read/write the data from/into a recording disk D. A cylindrical radial bearing 13a of an oil retaining metal is fixedly fitted on the inner peripheral surface of the bearing bush 12. The motor mounting plate 111 and the bearing bush 12 are made of an aluminum alloy. A substantially discal cover member 11a of an aluminum alloy is mounted at the lower end of the bearing bush 12, and a stator 17 is fixed on the outer periphery of the bearing bush 12. The stator 17 includes a stator core 17a of a silicon steel plate having teeth arranged at predetermined pitches along the peripheral direction on the outer diameter side, and an aluminum coil 17b wound on the teeth of the stator core 17a. The winding portion of the coil 17b is formed on the teeth.

The radial bearing 13a and the resin thrust bearing 13b arranged on the upper surface of the cover member 11a support the shaft 14 rotatably in such a manner as to have a rotary axis in vertical (axial) direction. A substantially cup-shaped rotor 15 including a rotor table 151 and a rotor holder 152 is fixed at the upper end of the shaft 14. The rotor table 151 constituting the upper wall portion of the rotor 15 made of an aluminum alloy doubles as a turn table. An annular buffer member 15a doubling as a stopper of the recording disk D is mounted in the neighborhood of the outer periphery of the upper surface of the rotor table 151. The recording disk D is placed through the buffer member 15a. A substantially annular rotor magnet 16 is arranged in opposed relation with the stator 17 on the inner peripheral surface of the cylindrical wall of the annular rotor holder 152 of a magnetic material welded to the rotor table 151. Annular magnets 110a, 110b are mounted on the upper surface inward of the stator core 17a of the stator 17 and the rotor table 151 in opposed relation thereto, respectively, and attract the rotor 15 axially downward.

A flange 12a is integrally arranged on the outer periphery at the upper end of the bearing bush 12. The flange 12a engages the rotor stopper 15b integrated with the lower surface of the upper wall inwardly of the rotor table 151 adjacent to the flange 12a thereby to prevent the rotor 15 from coming off upward. The rotor table 151 made of an aluminum alloy can further reduce the weight. The rotor stopper 15b can also be formed integrally.

A disk aligner 18 is arranged integrally and concentrically, as in FIG. 1, with the upper wall of the rotor 15, i.e. the central portion of the turn table. The disk aligner 18 includes a substantially cylindrical resin body case 18a fitted in the central hole of the recording disk D and a plurality of aligning pawl units 18b having resin aligning pawls 18c energized to protrude radially outward of the body case 18a and adapted to move in and out of the disk aligner 18. The aligning pawl units 18b are arranged equidistantly along the peripheral direction.

In the case where the central hole of the recording disk D is fitted on the disk aligner 18, the inner peripheral portion of the lower surface of the recording disk D comes into contact with the aligning pawls 18c. Under this condition, the recording disk D is pressed downward. Then, the aligning pawls 18c move diametrically inward against the energizing force of the coil spring 18d. Thus, the disk D can be moved downward.

A circuit board 19 is arranged and fixed by an adhesive or the like on the upper surface of the motor mounting plate 11 between the motor mounting plate 11 and the stator 17. The circuit board 19 has formed thereon a rotary drive circuit of the rotor 15 with predetermined electronic parts and a coil current control circuit for the stator 17. The circuit board 19 is formed of FPC, and therefore can be reduced in thickness as compared with the case in which the circuit board of epoxy resin is accumulated further on the motor mounting plate 11.

The motor mounting plate 11 and the circuit board 19, as shown in FIGS. 2 and 3, are formed with a plurality of openings (holes) 11b, and a part of each of the windings (near to the motor mounting plate in axial direction) of the coil 17b wound on the teeth of the stator core 17a is arranged through a part of the opening 11b. With this configuration, the stator 17 can be mounted at a lower position on the bearing bush 12, and the motor can be reduced in thickness by an amount equal to the axial size of the windings (protrusion) of the coil 17b adapted to be inserted into the opening 11b. Also, the elimination of the aluminum alloy by an amount equal to the size of the opening 11b of the motor mounting plate 11 can reduce the weight. Further, the air permeability in the motor is improved for an improved cooling capability. Apart from each of the openings into which each of the windings is inserted, a similar openings can be formed also at any portion of the circuit board 19 where the electronic parts or the disk drive device is not mounted, as far as the required rigidity can be maintained, at other than the threaded hole for mounting the motor mounting plate 11 on the disk drive device.

As shown in FIG. 4, the motor mounting plate 21, instead of a structure to cover the whole periphery of the rotor 15 and the stator 17, may be structured to cover a part of the periphery of the rotor 15 and support the bearing bush 12, as far as it has an area in which the circuit board with the required electronic parts mounted thereon to form the circuits can be arranged. As shown in FIG. 4, a plurality of openings 21a is formed in the motor mounting plate 21, and a part of each of the windings (near to the motor mounting plate in axial direction) of the coil 17b may be inserted into a part of the opening 21a. In this way, the thickness is reduced by forming the opening 21a, the weight is reduced by forming the motor mounting plate 21 of an aluminum alloy and the space is saved to further reduce the weight by reducing the area of the motor mounting plate at the same time.

In the embodiment described above, the motor mounting plate shown in FIGS. 2 to 4 is made of an aluminum alloy. As an alternative, a silicon steel plate may be used. The use of a silicon steel plate, for its high rigidity, makes it possible to form a lightweight, thin motor mounting plate while at the same time securing substantially the same rigidity as the conventional mounting plate of iron.

This invention is not limited to the embodiments described above, but can be variously modified without departing from the spirit of the invention.

In place of FPC used for the circuit board, for example, a board made from aramid may be used to reduce the weight.

Also, the aluminum windings described above can be replaced with windings of composite materials with aluminum as a main material (such as a copper-clad aluminum wire). The weight can thus be reduced as compared with the conventional enamel wire.

The motor mounting plate 1 and the bearing bush 2 may be made of a light metal or a light alloy other than aluminum as far as it is light in weight and high in heat conductivity.

Further, the embodiments of the invention described above may be variously combined with each other. For example, the motor mounting plate of an aluminum alloy having openings may be combined with the rotor 5 of a magnetic material.

The disk drive motor and the disk drive device according to the invention have the following advantages.

Specifically, in view of the fact that the motor mounting plate and the bearing bush are made of a light metal or a light alloy, the selected one has a higher heat conductivity than iron, the heat generated in the motor can be efficiently radiated while at the same time reducing the weight of the motor.

The motor mounting plate is formed of a silicon steel plate high in rigidity. By taking advantage of the high rigidity of the silicon steel plate effectively, therefore, substantially the same rigidity as the motor mounting plate of iron can be secured while at the same time reducing the thickness of the motor mounting plate in the direction of rotary axis. Also, the heat generated in the motor can be efficiently radiated and the motor can be reduced in weight at the same time. Since a magnetic silicon steel plate is used for the motor mounting plate, the job of assembling and otherwise handling the motor remains substantially the same as for the motor mounting plate of iron without increasing the cost.

The use of FPC for the circuit board can reduce both the weight and thickness.

The turn table is made of a light metal or a light alloy, the selected one has a higher heat conductivity than iron, and therefore can be prevented from being deformed by the heat generated from the motor.

The heat generated in the motor can be radiated efficiently, and in addition, the weight is remarkably reduced.

In view of the fact that the motor mounting plate and the bearing bush are made of a light metal or a light alloy such as aluminum or an aluminum alloy having a small specific gravity, the heat generated in the motor can be radiated through the bearing bush and the board taking advantage of the high heat conductivity thereof. At the same time, the motor weight is reduced.

The provision of the disk drive motor described above makes it possible to efficiently radiate the heat generated in the motor, and implement the disk drive device reduced in both weight and thickness.

This application is based on Japanese Patent Application serial No. 2004-076779 filed in Japan Patent Office on Mar. 17, 2004 and Japanese Patent Application serial No. 2005-030559 filed in Japan Patent Office on Feb. 7, 2005, the contents of which are hereby incorporated by reference.

1. A motor built into a disk device to rotate a data recording disk, comprising:
a motor mounting plate to mount the motor on the disk device;
a bearing bush arranged on the motor mounting plate;
a rotor rotatably supported on a periphery surface of the bearing bush through a bearing;
a turn table having the data recording disk placed thereon and rotating integrally with the rotor;
a rotor magnet mounted on the rotor;
a stator arranged in radially opposed relation with the rotor magnet; and
a circuit board fixed to the motor mounting plate; wherein
the motor mounting plate and the bearing bush are made of selected one of a light metal and a light alloy, the selected one has a higher heat conductivity than iron, and the circuit board is a flexible printed circuit board.

2. A disk drive motor according to claim 1, wherein
the turn table is made of selected one of a light metal and a light alloy and the selected one has a higher heat conductivity than iron.

3. A disk drive motor according to claim 1, wherein
the light metal and the light alloy are aluminum and an aluminum alloy, respectively.

4. A disk drive motor according to claim 1, wherein
the motor mounting plate has a plurality of openings, the stator comprises a stator core having a plurality of teeth radially arranged thereon, stator windings wound on each tooth of the stator core, and a part of each of the windings is inserted into each of the openings.

5. A disk drive motor according to claim 4, wherein
the windings are made of a composite material including copper and selected one of aluminum and an aluminum alloy.

6. A disk drive device comprising the disk drive motor according to claim 1 to rotationally drive the disk placed on the turn table.

7. A motor built into a disk device to rotate a data recording disk, comprising:
a motor mounting plate to mount the motor on the disk device;
a bearing bush arranged on the motor mounting plate;
a rotor rotatably supported on a periphery surface of the bearing bush through a bearing;
a turn table having the data recording disk placed thereon and rotating integrally with the rotor;
a rotor magnet mounted on the rotor;
a stator arranged in radially opposed relation with the rotor magnet; and
a circuit board fixed to the motor mounting plate; wherein
the motor mounting plate is formed of a silicon steel plate, the bearing bush is made of selected one of a light metal and a light alloy, the selected one has a higher heat conductivity than iron, and the circuit board is a flexible printed circuit board.

8. A disk drive motor according to claim 7, wherein
the turn table is made of selected one of a light metal and a light alloy and the selected one has a higher heat conductivity than iron.

9. A disk drive motor according to claim 7, wherein
the light metal and the light alloy are aluminum and an aluminum alloy, respectively.

10. A disk drive motor according to claim 7, wherein
the motor mounting plate has a plurality of openings, the stator comprises a stator core having a plurality of teeth radially arranged thereon, stator windings wound on each tooth of the stator core, and a part of each of the windings is inserted into each of the openings.

11. A disk drive motor according to claim 10, wherein
the windings are made of a composite material including copper and selected one of aluminum and an aluminum alloy.

12. A disk drive device comprising the disk drive motor according to claim 7 to rotationally drive the disk placed on the turn table.

13. A motor built into a disk device to rotate a data recording disk, comprising:
a motor mounting plate to mount the motor on the disk device;
a bearing bush arranged on the motor mounting plate;
a rotor rotatably supported on a periphery surface of the bearing bush through a bearing;
a turn table having the data recording disk placed thereon and rotating integrally with the rotor;
a rotor magnet mounted on the rotor;
a stator arranged in radially opposed relation with the rotor magnet; and
a circuit board fixed to the motor mounting plate; wherein
the motor mounting plate and the bearing bush are made of selected one of a light metal and a light alloy, the selected one has a higher heat conductivity than iron.

14. A motor built into a disk device to rotate a data recording disk, comprising:
a motor mounting plate to mount the motor on the disk device;
a bearing bush arranged on the motor mounting plate;
a rotor rotatably supported on a periphery surface of the bearing bush through a bearing;
a turn table having the data recording disk placed thereon and rotating integrally with the rotor;
a rotor magnet mounted on the rotor;
a stator arranged in radially opposed relation with the rotor magnet; and
a circuit board fixed to the motor mounting plate; wherein
the motor mounting plate is formed of a silicon steel plate, and the bearing bush is made of selected one of a light metal and a light alloy, selected one has a higher heat conductivity than iron.
